(19) United States
(12) Patent Application Publication
(10) Pub. No.: US 2023/0114350 A1
(43) Pub. Date: Apr. 13, 2023

(54) DIGITAL GIFTING SYSTEMS AND METHODS

(71) Applicants: Mehrak VAHIDI, Irvine, CA (US); Anita Sharifi NARANI, Mission Viejo, CA (US)

(72) Inventors: Mehrak VAHIDI, Irvine, CA (US); Anita Sharifi NARANI, Mission Viejo, CA (US)

(21) Appl. No.: 17/954,433

(22) Filed: Sep. 28, 2022

Related U.S. Application Data
(60) Provisional application No. 63/249,486, filed on Sep. 28, 2021.

(51) Int. Cl. G06Q 20/10; G06Q 20/32; G06Q 20/40; G06Q 20/36; G06Q 20/38

(52) U.S. Cl. CPC G06Q 20/10; G06Q 20/36; G06Q 20/384; G06Q 20/3263; G06Q 20/4014; G06Q 20/4015; G06Q 20/38215

(57) ABSTRACT

A digital gifting system and method utilizing a mobile device with a gifting application is disclosed. The mobile device is configured to receive from a gift sender a gift comprising an identifier of the gift sender, a custom content, and a gift amount, wherein the gift is only spendable if a phone number of the mobile device corresponds to a predetermined phone number associated with the gift; receiving a first selection from a user of the mobile device to accept the gift amount; displaying the identifier of the gift sender and the custom content; transmitting a first notification to the gift sender that the gift has been received by the user and the custom content has been displayed to the user; and after the gift amount has been spent by the user, transmitting a second notification to the gift sender indicating how the gift amount was spent by the user.

### CROSS REFERENCE OF THE RELATED APPLICATION

The present invention is based on and claims priority to U.S. provisional application 63/249,486 filed on Sep. 28, 2021, the entire content of which is incorporated herein by reference.

### TECHNICAL FIELD

The present invention is directed to digital gifting systems and methods using a mobile device, which relates to network communication, cloud computing, and graphic user interface technical fields.

### BACKGROUND

Digital gifting enables a person to express appreciations to others over a network such as the Internet without physical interaction with the others. Conventional digital gifting methods rely on emails, cellular messaging, Internet messaging, or social networking platform to convey gift card information to others. However, there is lacking a secure mechanism to ensure the receiver safely receives the gift. For example, a gift sender sending a gift may receive no confirmation from the gift receiver, and the gift receiver may be aware of an incoming gift, resulting the gift email or message remains unread and lost in a plurality of emails or messages of the receiver.

Furthermore, the conventional gifting methods have no control in who can redeem the gift. Since anyone who sees the gift card information is able to use the gift card balance in a purchase, there is no guarantee that the gift card can be safely delivered to the gift receiver through the aforementioned email or messaging methods.

Therefore, there is a need for an efficient and secure digital gifting system and method.

### SUMMARY

Before explaining at least one embodiment in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention relates to digital gift giving and receiving systems, methods, and a computer readable medium storing software for solving the problems of the conventional digital gifting technology. By way of example, various embodiments provide a platform that can instantly send a personalized video or picture message, along with a digital gift that can be spent anywhere via digital wallet such as ApplePay®, GooglePay®, or SamsungPay® also known as Tab and Go. Users can also gain access to exclusive deals nationwide where they can shop and support local businesses, but are not limited to spending their digital gifts at local businesses as they can spend it anywhere. The embodiments disclosed herein contain numerous inventive concepts and provide improvements to digital gifting technology.

In specific, the present invention discloses a digital gifting system comprising the mobile device and a server, and a digital gifting method using a mobile device containing a gifting software installed, wherein the mobile device is configured for receiving from a gift sender a gift comprising an identifier of the gift sender, a custom content, and a gift amount, wherein the gift is only spendable if a phone number of the mobile device corresponds to a predetermined phone number associated with the gift; receiving, by the gifting application installed on the mobile device, a first selection from a user of the mobile device to accept the gift amount; displaying, by the gifting application installed on the mobile device, the identifier of the gift sender and the custom content; transmitting, by the gifting application installed on the mobile device, a first notification to the gift sender that the gift has been received by the user and the custom content has been displayed to the user; and after the gift amount has been spent by the user, transmitting, by the gifting application installed on the mobile device, a second notification to the gift sender indicating how the gift amount was spent by the user.

In one embodiment, the same mobile device is further configured to send a gift. In specific, the mobile device is further configured for sending to a gift recipient, a second gift comprising an identifier of the user, a second custom content, and a second gift amount, wherein the second gift is only spendable if a phone number associated with the gift recipient’s device corresponds to a predetermined phone number associated with the second gift; receiving a third notification from the gift recipient indicating that the second gift has been received by the gift recipient and the second custom content has been displayed to the gift recipient; and optionally after the gift amount has been spent by the gift recipient, receiving a fourth notification from the gift recipient indicating how the gift amount was spent by the gift recipient.

In one embodiment, the user enters a gift recipient’s information and a gift amount to trigger a gift. The gift recipient’s information comprises a recipient’s phone number or email address.

In one embodiment, the custom content received by the mobile device and the second custom content sent by the mobile device each comprises at least one of an image, a video, a sound, or a text. In another embodiment, the custom content and the second custom content is optional.

In one embodiment, the mobile device is further configured for displaying an available spending amount to the user, wherein the available spending amount indicates the amount of money associated with the user account.

In one embodiment, the mobile device is further configured for initiating a purchase; transmitting a request to approve the purchase to the server; receiving an approval from the server; and receiving an indication that a purchase has been made.

In one embodiment, the mobile device is further configured for receiving a creation event of a merchant promotion, wherein the merchant promotion is associated with at least one of a product or a service; identifying a purchase is associated with the merchant promotion; receiving an input from the user indicating acceptance of the merchant promotion; and applying the merchant promotion to the purchase.

In the embodiments of the present invention, the server can be a local server, a web server, a cloud server, a centralized server, or a decentralized server. The server is configured for authenticating the user; associating the user with a user account, wherein the user account is linked with a digital wallet of the user; and storing, at a database associated with the server, an association binding the gift sender, the user, and the phone number associated with the gift. The database can be a local database with direct connection with the server or connected with the server through local area network (LAN). In one embodiment, the database can be a database remotely connected to the server, such remote connection includes, but is not limited to, wide area network (WAN), i.e. the Internet.

In one embodiment, the server is further configured for receiving a request to approve a purchase; transmitting an approval of the purchase; charging the digital wallet of the user account based on an amount of the purchase; and updating the available spending amount associated with the user account based on a balance of the digital wallet.

In one embodiment, the server is further configured for authenticating a payment terminal with a certificate issued by an independent organization; comparing a location related to the mobile device with a location of the payment terminal to authenticate the payment terminal; transmitting an indication that the purchase has been made.

In another embodiment, the user of the mobile device is a member of an Internet-based social networking site, and the Internet-based social networking site including a gifting occasion associated with the user; wherein before receiving the gift from the gift sender, the digital system further identifies a triggering event; retrieves the gifting occasion based on the triggering event; and presents a notice of the gifting occasion to the gift sender, wherein the notice includes an option for the gift sender to send the gift.

In one embodiment, the digital gifting system is further configured for determining a location of the mobile device; comparing the location of the mobile device to a payment terminal associated with a merchant; identifying an applicable merchant promotion associated with the location of the payment terminal; receiving the applicable merchant promotion; and applying the applicable merchant promotion to a purchase.

In one embodiment, the gift sender assigns the gift to a pot and the gift is selected from the pot randomly.

In one embodiment, the gift sender is a group of people; the identifier of the gift sender indicates the group of people; the customer content is a combination of content from each person in the group; and the gift amount is a combination of individual amount from each person in the group.

In one embodiment, the user can access the previous gifts sent, gifts received, and gifts purchased via the gifting application.

In order to protect junior users, the present invention also includes kid’s account that only allows a user to spend a received gift at merchants that sell kid’s products or provide kid’s services.

### BRIEF DESCRIPTION OF THE DRAWINGS

In the drawings, various embodiments of the present systems, methods, and computer readable medium are illustrated by way of example. It is to be expressly understood that the description and drawings are only for the purpose of illustration and in no way limit or define the scope of the present invention.

FIG. 1 illustrates a flowchart showing the steps of one embodiment of the present invention.

FIGS. 2A and 2B illustrates an exemplary flowchart showing the gifting flow of the present invention.

FIG. 3 illustrates the system architecture of one embodiment of the present invention.

FIG. 4 illustrates a flowchart showing the process for sending a gift. In step 401, the gift sender (giver) is authenticated by the gift sender’s phone number.

FIG. 5 illustrates a flowchart showing the process for receiving a gift.

FIG. 6 illustrates a flowchart showing the process of issuing a gift card with the gift amount.

FIG. 7 illustrates a flowchart showing the process of spending a gift amount at a point of sale (POS).

FIG. 8 illustrates a flowchart showing the process of sending a thank you note.

FIG. 9 illustrates a graphic user interface of the gift sender’s mobile device enabling the user to create the custom content.

FIG. 10 illustrates a graphic user interface of the gift sender’s mobile device displaying the custom content created in FIG. 9 and allowing the user to enter information about the gift recipient.

FIGS. 11 and 12 illustrate a graphic user interface of the gift sender’s mobile device notifying the user that the gift has been sent.

FIGS. 13 and 14 illustrate a graphic user interface of the gift recipient’s mobile device notifying the recipient user that a gift has been received.

FIGS. 15 and 16 illustrate a graphic user interface of the gift recipient’s mobile device prompting the recipient user to accept the gift.

FIGS. 17 and 18 illustrate a graphic user interface of the gift recipient’s mobile device allowing the recipient to add a gift card into the recipient’s digital wallet.

FIGS. 19-21 illustrate a graphic user interface of the mobile device showing a transaction history of the digital wallet and details of each transaction.

FIG. 22 illustrates a graphic user interface of the mobile device enabling the user to set donations.

FIG. 23 illustrates a graphic user interface of the gift recipient’s mobile device enabling the recipient to spend the received gift amount through the gifting application.

FIGS. 24-26 illustrate a graphic user interface of the merchant’s mobile device enabling the merchant to place deals on the gifting system and track the sales.

The embodiments of the present invention have been illustrated in all respects to be illustrative rather than restrictive. For example, a person skilled in the art will understand that the methods shown in the drawings are not limited to the specific steps shown, but are for illustrative purposes only. Those skilled in theart will further realize that the embodiments of the present invention are capable of many modifications and variations without departing from the scope of the present invention.

### DETAILED DESCRIPTION OF THE EMBODIMENTS

The present disclosure provides systems and methods for digital gifting. By way of example, various embodiments of the present invention provide methods for digital gifting using personal computing devices including, but not limited to, mobile computing devices like tablets, watches, cell phones, or any other smart devices.

In the disclosure, the term “gift sender” refers to a gift sending entity, and the term “gift recipient” refers to a gift receiving entity. It is noted that the mobile device in the disclosure can be a “gift sender” and a “gift recipient” at the same time since the disclosed mobile device with gifting application allows the user of the mobile device to send and receive gifts.

Embodiments of the invention allow users to personalize their digital gifts by uploading or creating their own videos, images, and/or audio recordings and/or bypicking a greeting card for a particular occasion (e.g. birthdays, graduation, Mother’s Day, holidays, corporate events, etc.). Further embodiments can provide feedback by communicating when a digital gift has been accepted and/or how thegift was spent. For example, gift recipients can provide a picture, animation, video, or text message displaying their purchase and thanking the digital gift sender or “gifter.”

Recipients can also share how they spent their digital gift (in order to share the exchange that would have otherwise taken place if they were given a physical gift). Various embodiments of the invention can be powered by Visa^{®} and Mastercard^{®}, so the gifts can be spent anywhere. The invention eliminates the need to purchase a Visa^{®} or Mastercard^{®} gift card or store gift cards (e.g. Target^{®}, Amazon^{®}), or the need to carry multiple gift cards.

In one example, the gift sender takes or uploads pictures or videos using an app on a mobile device. The user then uses the app interface to add a gift recipient. The user then indicates an amount for the gift on the app interface. The gifter may optionally add an audio, image, video, or text message. The gifter then uses the appinterface to send the gift instantly, or specifies to have the gift sent at a future date and time. The user then uses the app interface to pay the gift amount, which causes the gift to be sent. From the recipient’s side, the recipient gets a notificationthat they received a gift. Then the recipient uses the app to accept the gift and add it to a digital wallet. The recipient can then view the gift details including one or more pictures, videos, audio clips, or text messages sent by the gifter. The gift details get stored into the app and can be retrieved at any time. The recipient may then spend part or all of the gift anywhere. As soon as the recipient makes a purchase, or receives a new gift, the gift balance will be updated to reflect the newbalance. The recipient may also see local specials and available rewards. When the gift is spent, a “thank you” message, which may include an image, video, audio, and/or text, can be sent to the gifter.

Embodiments of the invention can also provide increased security. By way of example, card numbers are not exposed to the end user and all data/financial transactions are controlled by the gifting system, so cards can no longer be lost or stolen. Gift accounts belong to a specific user and are authenticated through a phone number verification. Further embodiments provide an authenticated gift access as means to provide security. When a gifter sends someone a digital gift, that gift is associated with the recipient’s phone number and only the recipient with the assigned phone number can spend the gift. So an unauthorized user cannot spend adigital gift even if they get their hands on the gift notification. The digital gift is also device agnostic. If users switch/upgrade their phone or other computing device, they can simply redownload the app and re-authenticate, and then they will have the same access they previously had (transactions, balance history, memories etc.).

Further embodiments provide instant and/or scheduled gifting. Fees may ormay not be charged in association with sending, receiving, or spending gifts. Any manner of payment may be used with embodiments of the invention. By way of example, users can use their phone’s digital wallet to make a gift purchase, or they can pay online using ApplePay®, GooglePay®, or similar digital payment services. The gifts of the present invention can be spent anywhere digital payment services are accepted.

Further embodiments provide gift consolidation and real-time balance updates. Embodiments can consolidate all digital gift balances into one, real-time,balance so the user always knows the amount they have available for spending.

Embodiments can automatically reload the digital gift card in their digital wallet as they receive new gifts. In addition, they are able to spend any portion of their balance, anytime they choose. Further embodiments can provide event reminders. Various embodiments can notify users that an event is coming up as a reminder to send a gift (this can also be based on past purchases or other collected or historicaldata).

Further embodiments can provide a social gifting experience by allowing users to interact socially within a digital gifting platform. For example, gift senders can be notified when their digital gift has been accepted. Gift recipients can be sent a “thank you” once they make a purchase, showing the gift sender what they purchased with their digital gift. Embodiments therefore close the gifting loop as the gift sender can have visibility into the digital gift purchase, which does not existanywhere today. Various embodiments can integrate with existing social media platforms such as Facebook, Instagram, and Twitter. The gifting app of the presentinvention can have various sharing features where people can share the messages they received (or any components of the gift process) to a social media platform of their choice. The present invention can link to social media to remind people of important birthdays/events so gift purchasers can receive reminders through the gifting system to send out gifts. The present invention includes a gifting network between users, which shows the relationships between gift senders, gift recipients, and their mutual friends.

Additional embodiments of the present invention provide a unique ability to identify a new type of network among the users comprising people that gift each other. Four different connections can be identified through the gifting system: (1) mutual gift senders; (2) mutual gift recipients; (3) a user’s gift sender community; and (4) a user’s gift recipient community.

Further embodiments provide a gift card buy-back program by purchasing people’s unwanted and/or unused conventional gift cards in exchange for a digital gift balance, allowing users to take advantage of the gifting platform and solving the unused gift card problem. In further embodiments people can quickly send daily gifts to each other in one-step quick transactions, such as a quick “thank you” or “thinking of you” gift.

Additional embodiments provide an electronic storefront, portal, and/or dedicated app for business owners where they can showcase their products, services, deals, announcements, and/or social impact score. Further embodiments incentivize users to spend their gifts at small to medium sized businesses (SMBs) by making SMBs more visible to users. This is not limited to SMBs and can be extended to any type of business. This can be accomplished in a number of ways. In one instance, a loyalty rewards program is provided. Businesses can set up theirloyalty reward program in the app so they do not have to create their own and can use the gifting platform to encourage repeat shopping. A cash-back or points system can also be used. Further embodiments can employ machine learning to detect user personas and promote related SMBs to maximize user spend. Further embodiments can provide real-time deals. For example, businesses can advertise “open slots” (availability in their calendar due to last minute cancelations) and someone can book these appointments through the app. This is a way to provide an effective targeted and focused Customer and Potential Customer Engagement Platform tool for Businesses that allows them to bring awareness to their brand andgenerate revenue where they cannot today. The embodiments of the present invention are point-of-sale system agnostic and can be spent anywhere an electronic payment system is accepted (e.g. Apple Pay® or Google Pay®).

In one instance, the business self-registers through the app to setup a store-front by entering business information and optionally by entering content, photos,and/or videos. The business user can also highlight social or other impact points, scores, and/or rankings. Further embodiments can utilize an impact score or ranking to highlight the positive impact a business is having on the environment and/or the community. For example, business participants can have an impact score out of 1-10 that is available to users of the app.

Additional embodiments further provide a platform for client engagement. The business owner may also set up a loyalty program and add real-time promotional offers. The business user may also view analytics including leads received, sales, user engagement, and other metrics. The business owner may alsodirectly engage users of the gifting platform by electronic messaging, email, phonecalls, in-app notifications, or other means.

Businesses can send users in-app notifications to share news about their products, services, and availability, including last-minute cancellations. In additional aspects, the gifting system can offer incentives when shopping is done with minority-owned businesses.

In further embodiments users can receive funds towards their favorite charities. From the platform, they can choose which charity they would like to donate to. In further aspects, the gifting platform can be used at corporate events, concerts, or other events and an event planner can broadcast gifts to the participants through gamification. In further aspects businesses can join an exclusive club or membership. Users will have special access to events and discounts provided by businesses who are part of the club. People not using the gifting platform and businesses who are not part of the club will not have access tothese benefits.

In additional embodiments users can win random gifts at various events (business events, online events, etc.). The event sponsor can send a batch of digital gifts to a specified group of people, with random values, and a total capped value. In additional embodiments businesses can send bulk gifts to clients and users.

In further embodiments of the invention a physical, self-loading gift card can be used. A user can pre-purchase (or receive them as part of a membership) a stack of “empty cards” and when they want to go somewhere, they can use theirown phone (the app) to load funds onto the card and add their personal gifting message to it. Once the recipient receives the card, they can use their phone to “unload” the balance and view the gift details. Once a card has been unloaded, it can be reloaded and gifted to someone else. This reduces plastic waste. Funds canbe loaded on the card using NFC and/or QR-codes, for example. In further embodiments a medium other than a physical card can be used including a gift tag,label, sticker, piece of paper, etc.

In one embodiment, the present invention includes a gift tag or gift card (or any medium that takes the data the gift sender is inputting and unloads the corresponding data when the gift recipient unloads it). The gift tag (or any other medium) cannot be used if lost or stolen, but adding money is optional, all information will be in the gift account. For example, the gift tag can comprise a QR code, the gift sender can scan the gift tag (QR code in this example) and input data into the app (data such as, but not limited to, amount, photos, videos, messages, etc.) At this point the gifting medium (gift tag in this example) is considered to be “loaded.” The gift recipient will scan the gifting medium (gift tag in this example) and they will receive the gift details and the gift balance (optional) through their app. Once the gift recipient scans the gifting medium (gift tag in this example) and views the gift details in the app, the gifting medium (gift tag in this example) is considered “unloaded.” The gift recipient can later re-gift the gifting medium (gift tag in this example) to a second user (no limit as to how many times the gifting medium can be re-gifted).

In additional embodiments a group of people can collaborate through the appand send their digital gift to one person as a single large gift. In further embodiments the system allows bundling a digital gift with an actual product through an affiliate. This can be florists, bakeries, etc. that will deliver add-ons along with the digital gift product for a more personalized gifting experience. In additional aspects, a registry can be used. For example, a user can register an event (baby shower, wedding, etc.) with the disclosed system to receive one, consolidated, digital-gift balance that can be spent anywhere. In yet further aspectsembodiments of the present invention can provide a real-time social gift feed, which can be showcased at events on projectors (e.g. weddings), displaying the various videos, pictures, and other messages that have been sent to the host throughthe platform. In additional aspects, embodiments can provide a profile for different people in the family where users can have parental control over where the balance is spent, as well as visibility into messages being sent to the children and their total gift balance. Similarly, businesses can enroll in a “perks” program, which is a distribution channel for businesses who want people to test their products. They can sponsor digital gifts (or various components thereof) and send their target audience (within the gifting platform) samples of their products.

In one embodiment, corporations can send their employees or any other group (inside or outside of their organization) gifts in bulk. In another embodiment, event organizers (concerts, conferences, expos, etc.) can send random value gifts to some or all participants and winners will receive a notification and can accept their gifts, the gift will be added to their consolidated gift balance (e.g. payment account).

In one embodiment, random gifts are sent to random users occasionally. In another embodiment, users can pick from presetdaily gifts such as “Coffee on me” or “Spa For You” and send them to the recipientwith one click.

In additional embodiments kids can be limited to spending their digital giftat “kid friendly merchants” and businesses offering activities for same-aged individuals (e.g. go-karting, escape rooms, etc.).

Further embodiments provide that a large number of people will have a gifting account that any gift sender can utilize to give a gift to them, just like a bank account. In that way, membership and participation in the gifting system can be asubiquitous as social media, and indeed may be linked or tied to social media accounts.

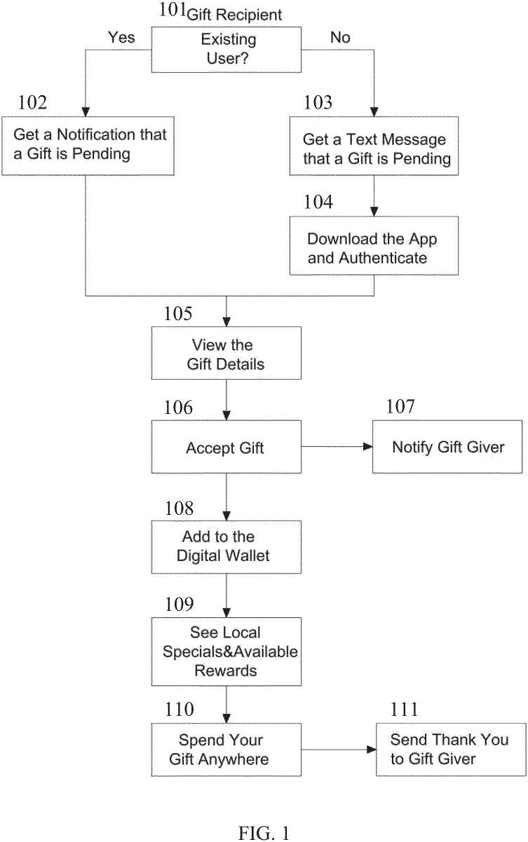

FIG. 1 illustrates a flowchart showing the steps of one embodiment of the present invention. In step 101, when a gift is sending to a recipient, the system first verifies whether the recipient is an existing user. If the recipient is an existing user (i.e. the user’s mobile device already has the gifting application installed), then, in step 102, the gifting application will display a notification on the mobile device indicating a new gift is just received. Otherwise, in step 103, the user’s mobile device will receive a text message via a cellular network indicating a gift is being sent to the recipient and in step 104 prompting the user to download and install the gifting application on the user’s mobile device. After the user downloads and installs the gifting application, the user will then be directed to an authentication process for creating a new account.

After creating the new account, or the recipient being an existing user, in step 105, details about the gift will be displayed through the gifting application to the user. The details include an identification of the gift sender, a custom content, and the gift amount. In step 106, the user will be prompted to either accept or deny the gift. In step 107, The gift sender will be notified about the recipient’s acceptance or denial. If the recipient accepts the gift, in step 108, the gift amount will be added into the digital wallet associated with the user’s account.

In step 109, the user can further use the gifting application to see local special offers, wherein special deals within a proximity to the user will be displayed to on the gifting application. Also, the gifting application shows available rewards associated with the offers. In step 110, the user can spend the balance on the digital wallet by making a purchase within the gifting application or by scanning the mobile device at a point of sale (POS) of a merchant, and after the purchase in step 111, the user is prompted with an option to send a “thank you” notification to the gift sender.

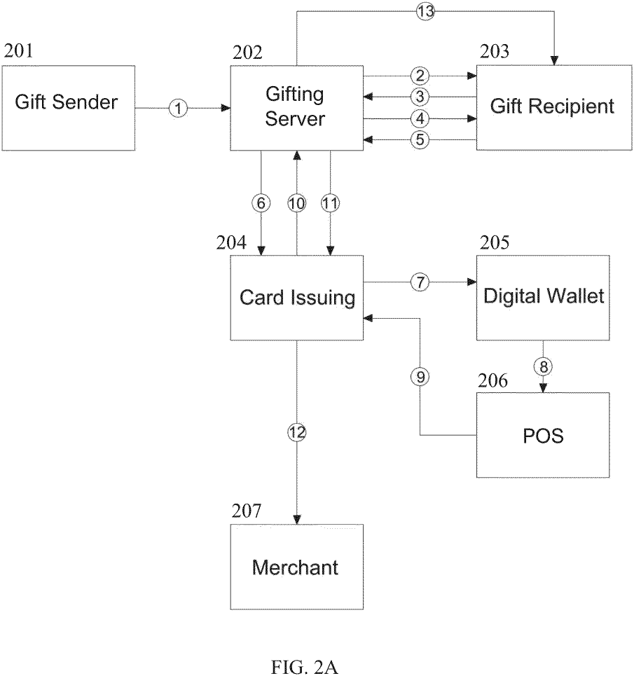

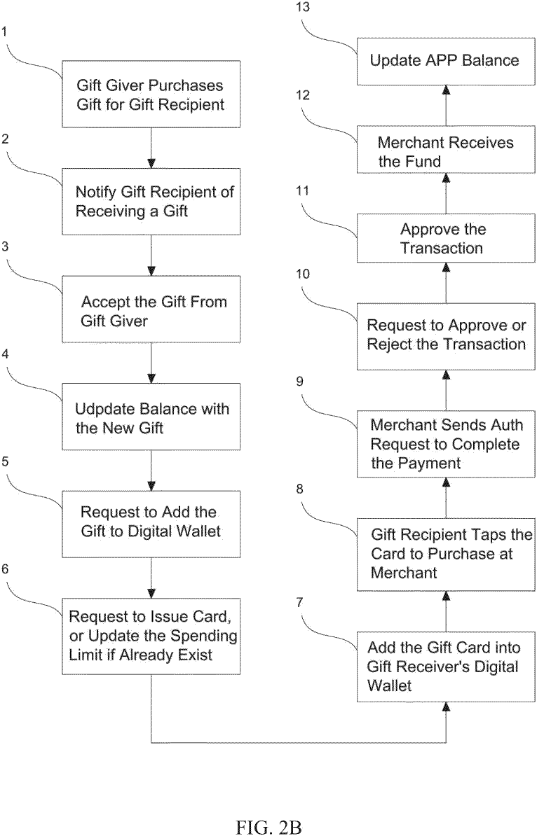

FIGS. 2A and 2B illustrates an exemplary flowchart showing the gifting flow of the present invention. In this example, in step 1, gift sender 201 purchases a gift using the gifting application on the mobile device and sends the gift to a gift recipient 203 via entering the gift recipient’s information in the gifting application. In step 2, the gifting server 202 receives the gift directing to the gift recipient 203 and issues a notification to the gift recipient’s mobile phone. In step 3, the gift recipient 203 accepts the gift via a gifting application installed on the gift recipient’s mobile device, and the gift recipient’s mobile device sends a notification back to the server 202 acknowledging the acceptance of the gift. In step 4, the server 202 sends an update of the gift recipient’s account balance to the gift recipient’s mobile device.

In another embodiment, the gift recipient 203 may receive a gift from the gift sender 201 through the gifting application, and in step 5, while the gift recipient 203 has a positive balance on his/her gifting account, the gift recipient 203 can issue a digital gift card (e.g. Mastercard or Visa) for himself/herself in order to spend the gift. After the gift recipient 203 accepts required terms and conditions, a request for issuing a digital gift card will be sent to the gifting server 202. In step 6, the gifting server 202 sends a request to a card issuing platform 204 requesting for a digital gift card and the card issuing platform 204 funds the digital gift card with the gifting account associated with the gift recipient 203, and the server 202 further updates the spending limit if a spending limit already exists. In step 7, the gifting server 202 sends a notification to the gift recipient 203 indicating the digital gift card is ready to be used, and the card issuing platform 204 allows the digital gift card to be added in the gift recipient’s digital wallet 205.

After the balance of the digital wallet of the gift recipient’s account has been updated with the gift balance, in step 8, the gift recipient 203 makes a purchase using the digital wallet 205 at a point of sale (POS) 206 of a merchant 207 by tapping the gift recipient’s mobile device. In steps 9 and 10, the POS 206 of the merchant 207 sends an authentication request through the card issuing platform 204 to the gifting server 202 requesting approval for the transaction. In step 11, the gifting server 202 approves the transaction and notifies the card issuing platform 204. In step 12, the card issuing platform 204 process the transaction and allocates the amount associated with the purchase into the merchant’s account. In step 13, the gift recipient’s account balance is updated and displayed to the gift recipient 203.

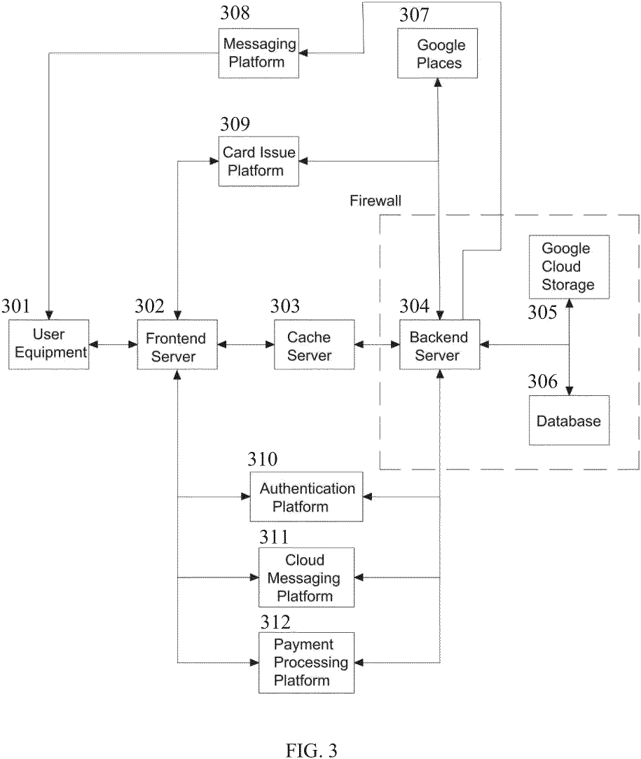

FIG. 3 illustrates the system architecture of one embodiment of the present invention. As shown in FIG. 3, the gifting system includes a user equipment 301 (e.g. a mobile device) on the client side, and a plurality of servers on the server side. In specific, the gifting server 202 includes a frontend server 302, a cache server 303, a backend server 304, a database 306, a remote storage 305, and a cloud marketplace 307. The frontend server 302 handles interactions with the mobile device 301 and is in communication of various of platforms such as card issuing platform 309, authentication platform 310, cloud messaging platform 311, and payment processing platform 312. The backend server 304 acts as the core of the gifting server 202 that consolidates and processes information from the frontend server 302, presents data to the frontend server 302 and the mobile device 301, and stores all related data of the gifting system in the database 306 and the remote storage 305. The cache server 303 caches frequently requested information from the backend server 304 to share the backend server’s loading, and the cloud marketplace 307 provides all hardware and software needs of the backend server via Platform-as-a-Service (PAAS), Software-as-a-Service (SAAS), or Infrastructure-as-a-Service (IAAS). The backend server 304 is in communication with a messaging platform 308 such as a cellular messaging system or an Internet messaging system for communicating with the mobile device. The card issuing platform 309 controls gift card issuing and maintains the amount of the gift cards. The authentication platform 310 guards the security of the gifting system by verifying the accessing users. The cloud messaging platform 311 facilitates the communication between the gifting servers, the gifting application, and the users, and the payment processing platform 312 handles the transactions through which the gifts are purchased.

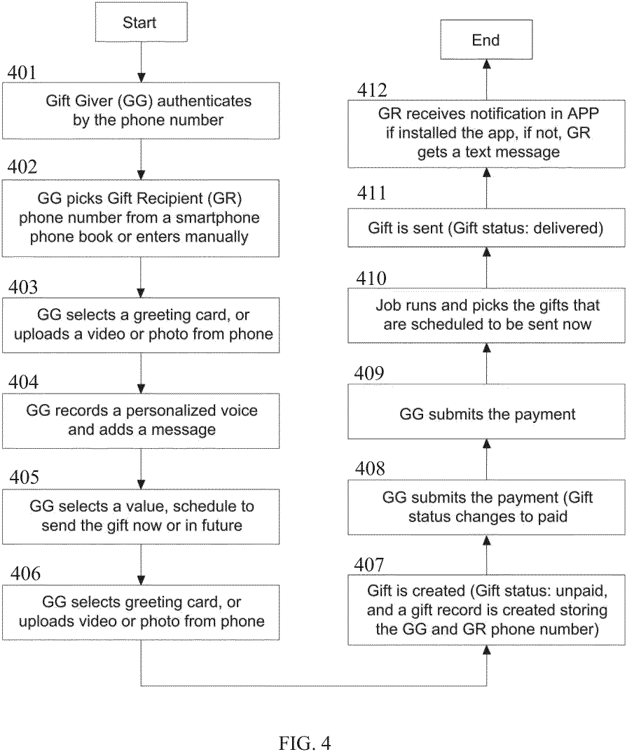

FIG. 4 illustrates a flowchart showing the process for sending a gift. In step 401, the gift sender (giver) is authenticated by the gift sender’s phone number. In step 402, the gift sender enters information about a gift recipient or selects a gift recipient from the gift sender’s phone book stored in the gift sender’s smartphone. In step 403, the gift sender selects one of the preset greeting card provided by the gifting application, or the gift sender creates his/her own greeting card by uploading a video or image or selecting an existing video or image stored at the gift sender’s phone. In step 404, the gift sender adds a personalized voice and message to the greeting card. In step 405, the gift sender selects a value indicating a schedule to send the gift (now or a time in the future). In step 406, the gift sender selects one of the created greeting card to be sent along a gift. In step 407, the gift sender enters the amount of the gift, and a pending (unpaid) gift is created in the system associated with both the gift sender’s phone number and the gift recipient’s phone number. In step 408, the gift sender verifies the gift information is correct. In step 409, the gift sender submits a payment for the gift via the gifting application. In step 410, the gifting application places the gift into a processing queue according to the gift schedule set by the gift sender. In step 411, the gift is sent to the recipient according to the schedule requested by the gift sender and the gifting application displays a delivered message to the gift sender. In step 412, the give recipient receives a notification from the gift recipient’s mobile gifting application about the incoming gift. If the gifting application has not yet installed in the gift recipient’s mobile device, the gift recipient’s mobile device receives a text message about the incoming gift over the cellular phone, with a link to download the gifting application so that the gift recipient can accept the gift after downloading and installing the gifting application.

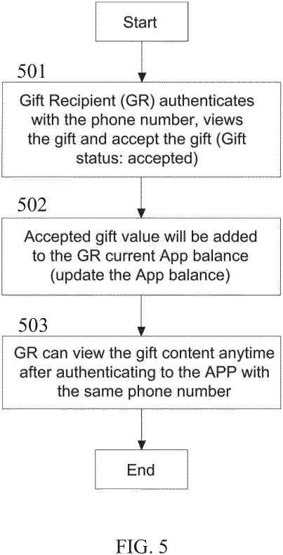

FIG. 5 illustrates a flowchart showing the process for receiving a gift. In step 501, if the gift recipient has already the gifting application installed in the gift recipient’s mobile device, the gift recipient is authenticated when logging in to the gifting application, otherwise, the gift recipient is provided with a link to download and install the gifting application, and after the gifting application is installed, the gift recipient is authenticated and a new account is created for the gift recipient. In step 502, the gift recipient is prompted whether to accept the gift, and when the gift recipient accepts the gift, the amount of the gift will be added to the digital wallet of the gift recipient and reflected on the gift recipient’s account. In step 503, the gift content (i.e. custom content) will remain with the gift recipient’s account after acceptance of the gift, so that the gift recipient can view the gift content any time after authenticating to the gifting application with the same phone number (i.e. the recipient can always view his/her previous gift content by logging in to the gifting application using the same phone number).

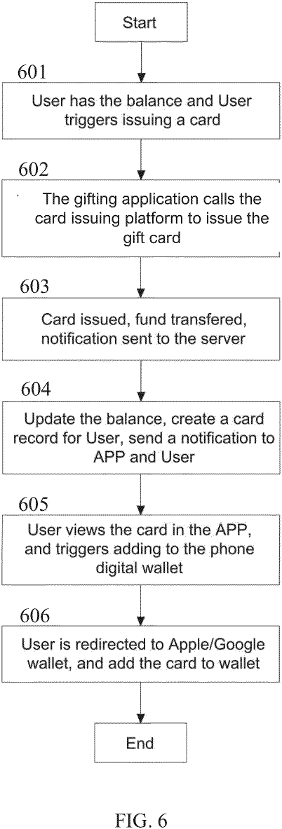

FIG. 6 illustrates a flowchart showing the process of issuing a gift card with the gift amount. In step 601, the user having a greater than zero balance in his/her account can trigger an issue of a gift card. In step 602, the gifting application requests a card issuing platform to issue a gift card and fund the gift card with an amount set by the user. In step 603, the card issuing platform issues the gift card and transfers the fund from the user’s gifting account to the digital gift card, and the card issuing platform sends a notification to the gifting server. In step 604, the gifting server updates the balance of the user’s account, creates a card record for the user, and sends a notification to the user indicating the gift card is ready to be viewed. In step 605, the user can view the gift card in the gifting application and trigger to add the gift card to a digital wallet associated with the mobile device. In step 606, the user is redirected to a digital wallet application (e.g. Apple®/Google® wallet), and the user is provided an option to add the gift card to the wallet.

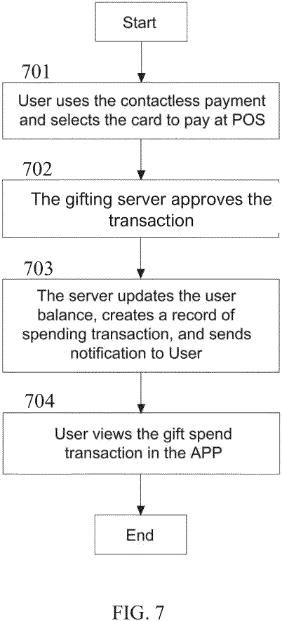

FIG. 7 illustrates a flowchart showing the process of spending a gift amount at a point of sale (POS). In step 701, the user having balance in his/her gifting account can scan the digital wallet on the mobile device at a POS to complete a purchase. In step 702, a request for approving the transaction is sent to the gifting server. In step 703, the gifting server approves the transaction, updates the balance of the user account, creates a record of the spending, and sends a notification to the mobile device indicating the transaction has been completed. In step 704, the user views the gift spending transactions in the gifting application.

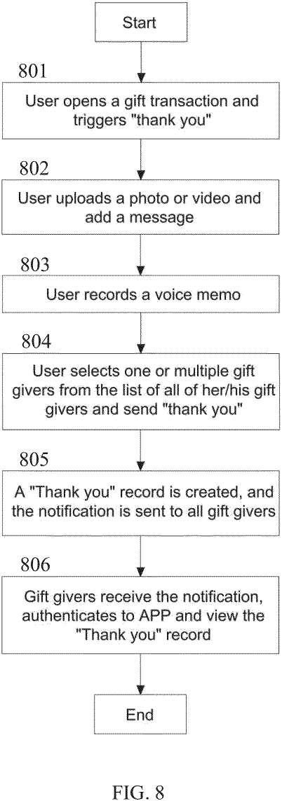

FIG. 8 illustrates a flowchart showing the process of sending a thank you note. In step 801, the user views a list of gift transactions on the gifting application, and the user triggers sending of a “thank you” note. In step 802, the user creates thank you content by uploading a photo or video and adding a message. In step 803, the user can record a voice memo and add the voice memo into the thank you content. In step 804, the user selects one of the gift transaction among the list of gift transactions to send the thank you note to. In step 805, the thank you note with thank you content is recorded by the gifting application, and the thank you note is sent to all gift senders of the selected gift transaction. In step 806, the gift senders of the selected gift transaction receive a notification of the thank you note, and can log in to their own gifting application to view the thank you content.

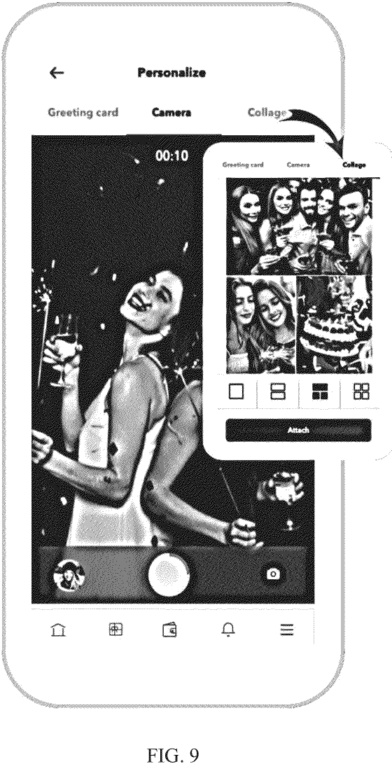

FIG. 9 illustrates a graphic user interface of the gift sender’s mobile device enabling the user to create the custom content. As shown in FIG. 9, the user is enabled to take photos or videos for the custom content, as well as select existing photos or videos stored in his/her mobile device.

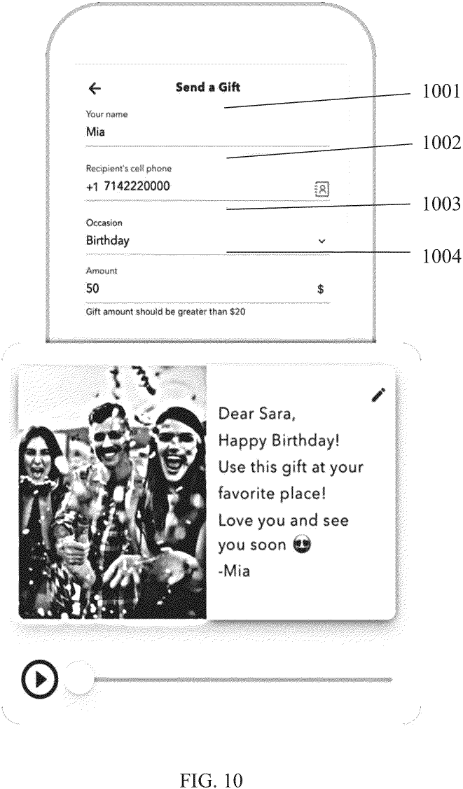

FIG. 10 illustrates a graphic user interface of the gift sender’s mobile device displaying the custom content created in FIG. 9 and allowing the user to enter information about the gift recipient. The recipient information includes the recipient’s name 1001, recipient’s phone number 1002, an occasion for the gift 1003, and a gift amount 1004. If the custom content includes a video or an audio, a play button is also displayed allowing the user to preview the video or the audio.

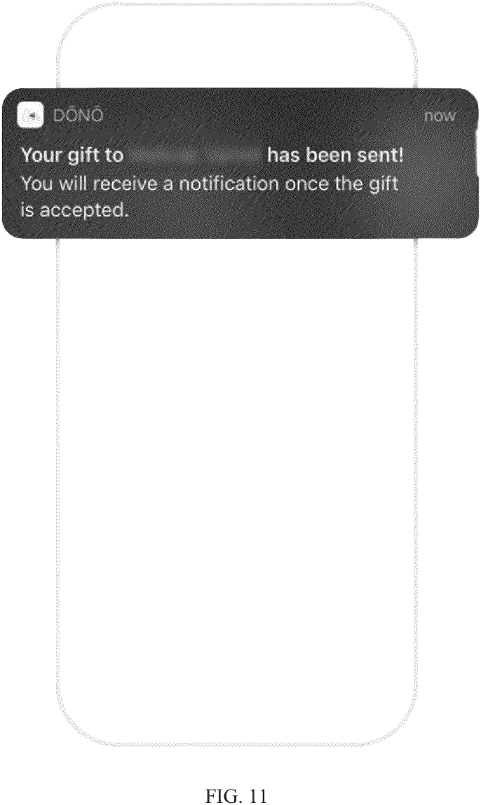

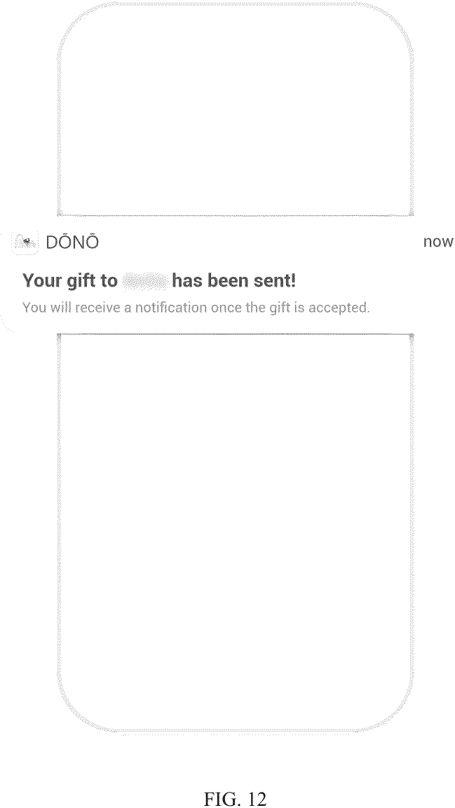

FIGS. 11 and 12 illustrate a graphic user interface of the gift sender’s mobile device notifying the user that the gift has been sent.

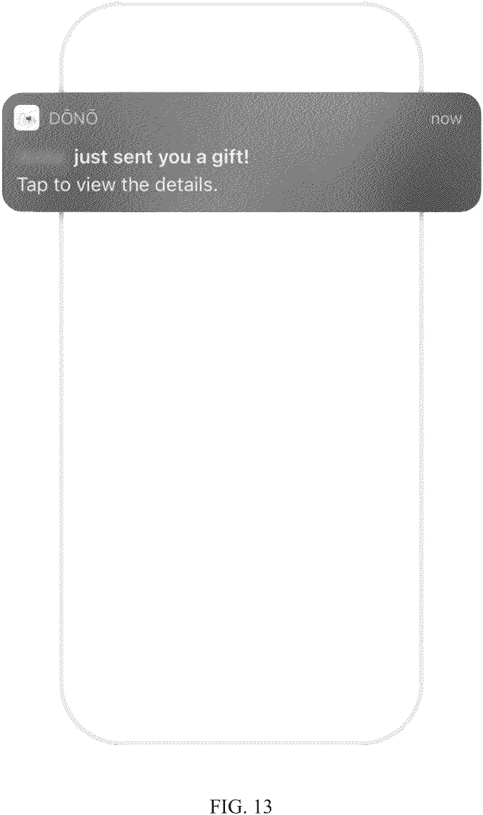

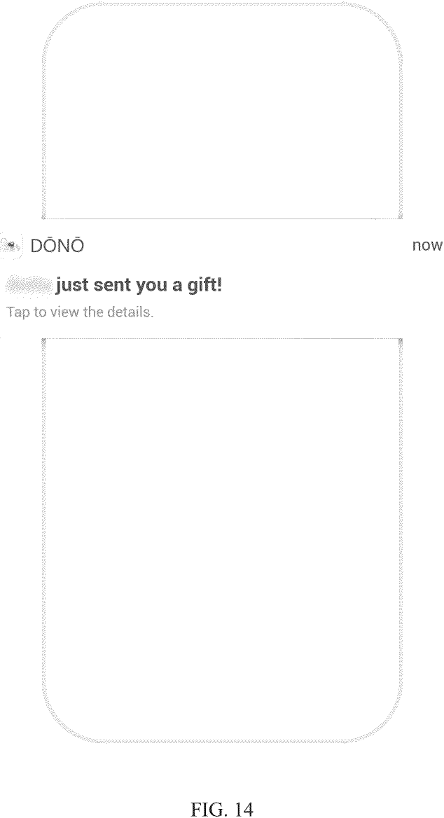

FIGS. 13 and 14 illustrate a graphic user interface of the gift recipient’s mobile device notifying the recipient user that a gift has been received.

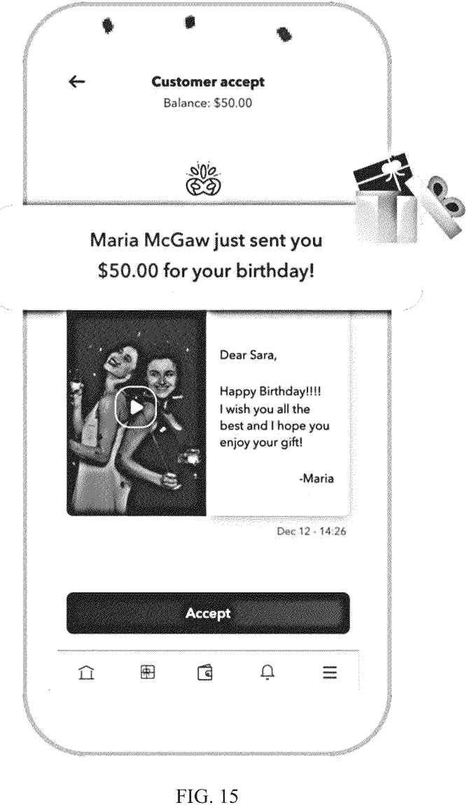

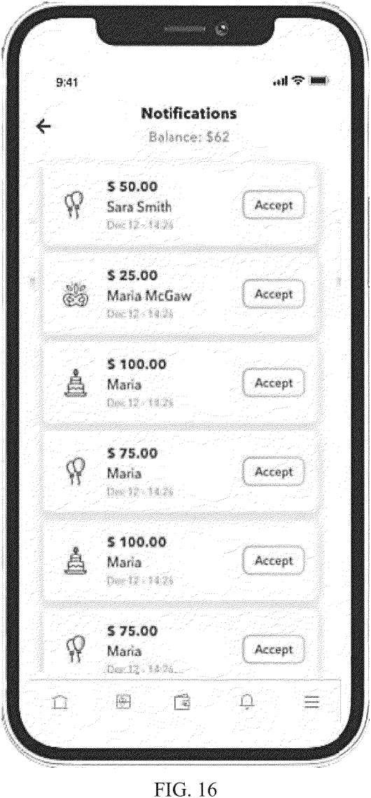

FIGS. 15 and 16 illustrate a graphic user interface of the gift recipient’s mobile device prompting the recipient user to accept the gift. FIG. 15 shows the custom content, an identifier of the gift sender, and the gift amount are displayed to the recipient. If the custom content includes a video or an audio, a play button is displayed allowing the recipient to play the video or the audio. If multiple gifts are pending to be accepted by the recipient, a list of gifts is displayed as shown in FIG. 16.

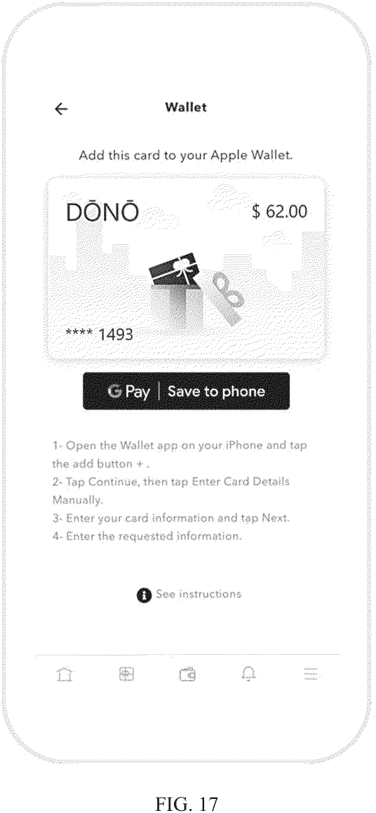

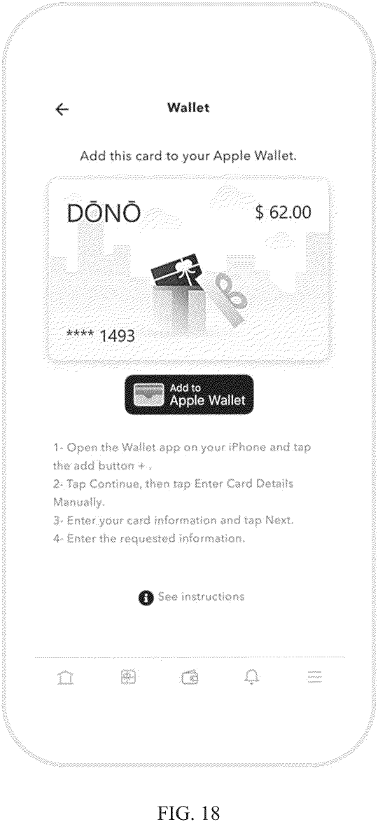

FIGS. 17 and 18 illustrate a graphic user interface of the gift recipient’s mobile device allowing the recipient to add a gift card into the recipient’s digital wallet.

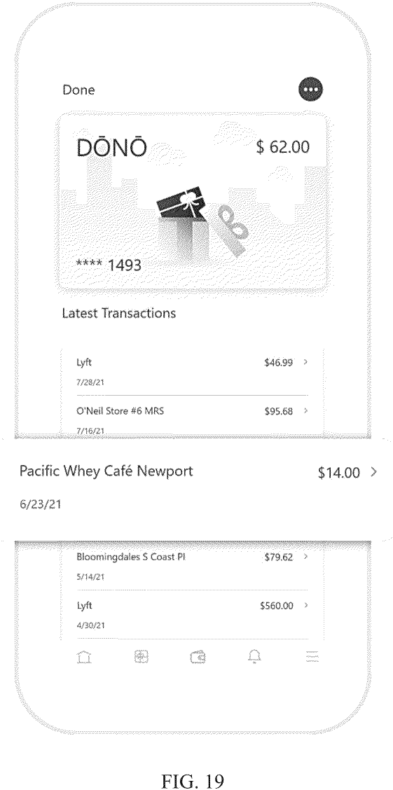

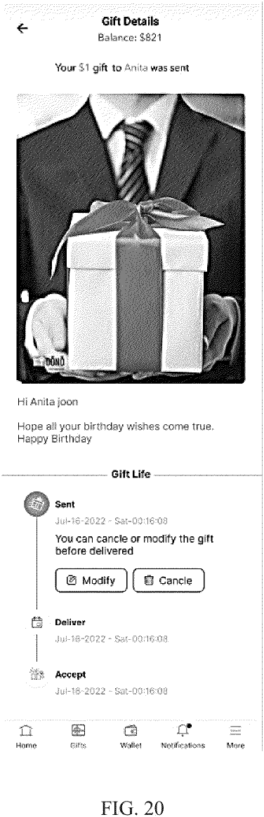

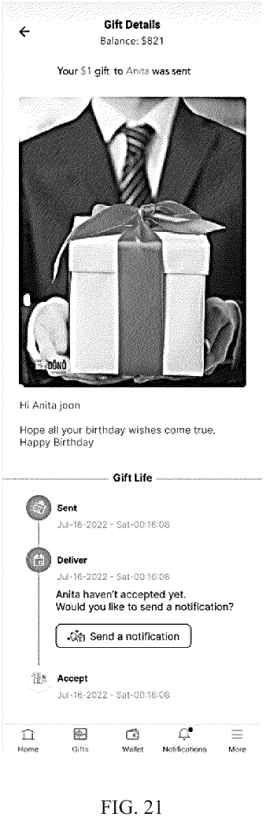

FIGS. 19-21 illustrate a graphic user interface of mobile device showing a transaction history of the digital wallet and details of each transaction. The user can click on one of the transactions shown in FIG. 19 to view details about the transaction, as shown in FIGS. 20-21.

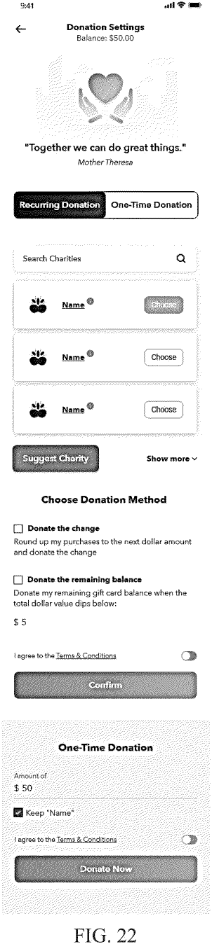

FIG. 22 illustrates a graphic user interface of the mobile device enabling the user to set donations. As shown in FIG. 22, a list of charities is displayed to the user and allowing the user to donate the change of a purchase, donate the remaining balance of the user’s gifting account, performing a one-time donation, or setting up a recurring donation to a charity.

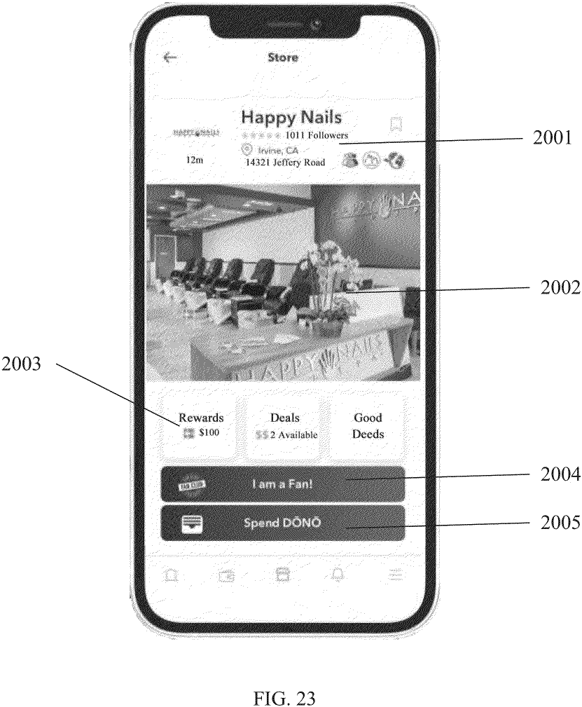

FIG. 23 illustrates a graphic user interface of the gift recipient’s mobile device enabling the recipient to spend the received gift amount through the gifting application. As illustrated in FIG. 20, deals are displayed via the gifting application, along with details of a product or a service 2001, multimedia content regarding the deals 2002, rewards associated with the deals 2003, a fan button 2004 to get updates about a particular deal, and a spend button 2005 to spend the received gift amount on a particular deal.

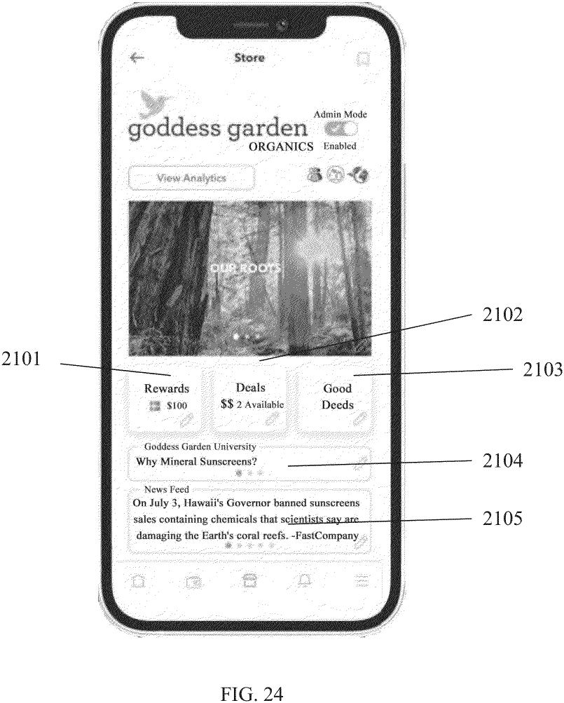

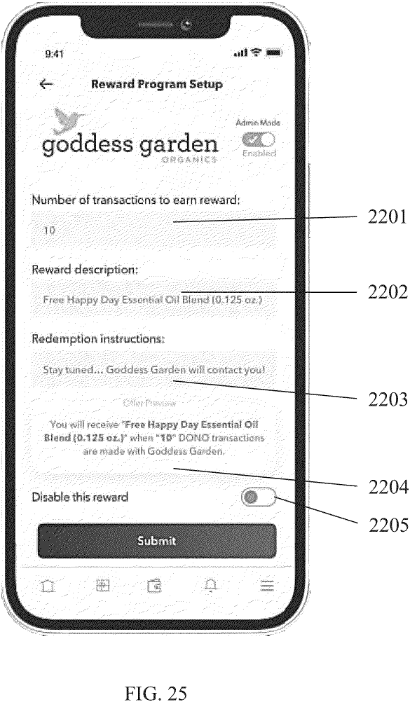

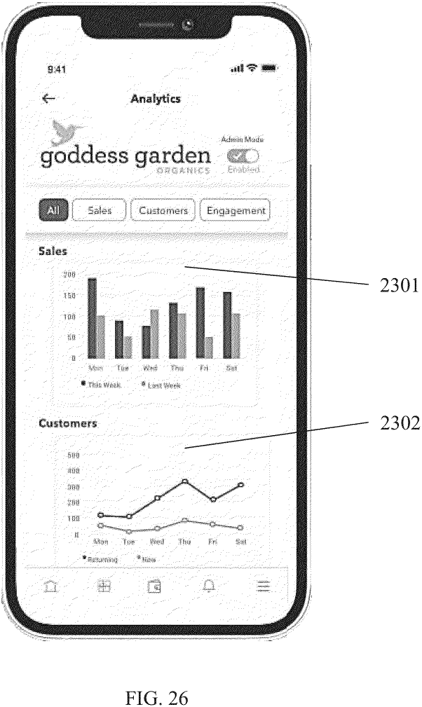

FIGS. 24-26 illustrate a graphic user interface of the merchant’s mobile device enabling the merchant to place deals on the gifting system and track the sales. As shown in FIGS. 21 and 22, the merchant can upload multimedia showing the related product or service, setup a reward 2101 for the deal 2102, enter descriptions 2103, 2104, 2105, and 2202 about the deal and reward, setup how the reward can be earned 2201, 2203, and 2204, and toggling to disable a particular reward 2205. Once a deal is setup, the merchant is provided with an analytics page as shown in FIG. 23, where the merchant can view the sales progress including a chart 2301 showing sales over time and a chart 2302 showing a number of new customers and a number of returning customers each day.

One of skill in the art will understand that the features of the gifting methodsand systems disclosed herein may be used together to create further embodiments of the present invention. While the invention has been described in detail in connection with specific embodiments, it should be understood that the invention is not limited to the above-disclosed embodiments. Rather, a person skilled in the art will understand that the invention can be modified to incorporate any number of variations, alternations, substitutions, or equivalent arrangements not heretofore described, but which are commensurate with the spirit and scope of the invention. Specific embodiments should be taken as exemplary and not limiting.

1. A digital gifting method using a mobile device, comprising:
receiving from a gift sender, by a gifting application installed on the mobile device, a gift comprising an identifier of the gift sender and a gift amount, wherein the gift is only spendable if a phone number of the mobile device corresponds to a predetermined phone number associated with the gift;
receiving, by the gifting application installed on the mobile device, a first selection from a user of the mobile device to accept the gift amount;
displaying, by the gifting application installed on the mobile device, the identifier of the gift sender and the gift amount;
transmitting, by the gifting application installed on the mobile device, a first notification to the gift sender that the gift has been received by the user; and
after the gift amount has been spent by the user, transmitting, by the gifting application installed on the mobile device, a second notification to the gift sender indicating how the user spent the gift amount.

2. The digital gifting method according to claim 1, further comprising:
sending, by the gifting application installed on the mobile device, to a gift recipient, a second gift comprising an identifier of the user and a second gift amount, wherein the second gift is only spendable if a phone number associated with the gift recipient’s device corresponds to a predetermined phone number associated with the second gift;
receiving, by the gifting application installed on the mobile device, a third notification from the gift recipient indicating that the second gift has been received by the gift recipient; and
after the gift amount has been spent by the gift recipient, receiving, by the gifting application installed on the mobile device, a fourth notification from the gift recipient indicating how the gift recipient spent the gift amount.

3. The digital gifting method according to claim 1, wherein the gift further comprises a custom content, and the custom content comprises at least one of an image, a video, a sound, or a text.

4. The digital gifting method according to claim 1, further comprising:
authenticating the user by a server;
associating, by the server, the user with a user account, wherein the user account is linked with a digital wallet of the user; and
storing, at the server, an association binding the gift sender, the user, and the phone number associated with the gift.

5. The digital gifting method according to claim 4, further comprising:
displaying, by the gifting application installed on the mobile device, an available spending amount to the user, wherein the available spending amount indicates the amount of money associated with the user account.

6. The digital gifting method according to claim 5, further comprising:
initiating a purchase from the gifting application installed on the mobile device;
transmitting, by the gifting application installed on the mobile device, a request to approve the purchase to the server;
receiving, by the gifting application installed on the mobile device, an approval from the server; and
charging, by a card issuing platform, a digital gift card in the digital wallet of the user.

7. The digital gifting method according to claim 6, further comprising:
updating, by the server, the available spending amount associated with the user account based on a balance of the digital wallet.

8. The digital gifting method according to claim 7, further comprising:
authenticating, by the server, a paymentterminal with a certificate issued by an independent organization.

9. The digital gifting method according to claim 8, further comprising:
comparing, by the server, a location related to the mobile device with a location of the payment terminal to authenticatethe payment terminal;
transmitting, by the server, an indication that the purchase has been made; and
receiving, by the gifting application installed on the mobile device, the indication.

10. The digital gifting method according to claim 1, further comprising:
setting, by the user via the gifting application installed on the mobile device, a network among users, wherein the network is defined in relation to each other user using one or more of the following relationships: (1) mutual gift senders; (2) mutual gift recipients; (3) a user’s gift sender community; and (4) a user’s gift recipient community.

11. The digital gifting method according to claim 1, further comprising:
if the user is a member of an Internet-based social networking site and the Internet-based social networking site including a gifting occasion associated with the user:
identifying a triggering event;
importing the gifting occasion based on the triggering event; and
presenting a notice of the gifting occasion to the gift sender, wherein the notice includes an option for the gift sender to send the gift.

12. The digital gifting method according to claim 1, further comprising:
selecting, by the user via the gifting application installed on the mobile device, a charity from a list of charities; and
sending the gift toward the selected charity.

13. The digital gifting method according to claim 1, further comprising:
receiving, by the gifting application installed on the mobile device, a creation event of a merchant promotion, wherein the merchant promotion is associated with at least one of a product or a service.

14. The digital gifting method according to claim 13, further comprising:
identifying, by the gifting application installed on the mobile device, a purchase is associated with the merchant promotion;
receiving, by the gifting application installed on the mobile device, an input from the user indicating acceptance ofthe merchant promotion; and
applying, by the gifting application installed on the mobile device, the merchant promotion to the purchase.

15. The digital gifting method according to claim 1, further comprising:
determining a location of the mobile device;
comparing the location of the mobile device to a payment terminal associated with a merchant;
identifying an applicable merchant promotion associated with the location of the payment terminal;
receiving the applicable merchant promotion; and
applying the applicable merchant promotion to a purchase.

16. The digital gifting method according to claim 1, wherein the gift sender assigns the gift to a pot and the gift is selected from the pot randomly.

17. The digital gifting method according to claim 1, wherein,
the gift sender is a group of people;
the identifier of the gift sender indicates the group of people;
the customer content is a combination of content from each person in the group; and
the gift amount is a combination of individual amount from each person in the group.

18. The digital gifting method according to claim 4, wherein the user account is a kid’s account and only allows spending at merchants that sell kid’s products or provide kid’s services.

19. A non-transitory computer readable medium comprising a gifting application, wherein when the gifting application is executed by a processor of a mobile device, causing the mobile device to:
receiving from a gift sender a gift comprising an identifier of the gift sender, a custom content, and a gift amount, wherein the gift is only spendable if a phone number of the mobile device corresponds to a predetermined phone number associated with the gift;
receiving a first selection from a user of the mobile device to accept the gift amount;
displaying, by the gifting application installed on the mobile device, the identifier of the gift sender and the custom content;
transmitting a first notification to the gift sender that the gift has been received by the user and the custom content has been displayed to the user; and
after the gift amount has been spent by the user, transmitting a second notification to the gift sender indicating how the user spent the gift amount.

20. A digital gifting system, comprising:
a mobile device with a gifting application installed therein, wherein the gifting application causes the mobile device to:
receiving from a gift sender a gift comprising an identifier of the gift sender, a custom content, and a gift amount, wherein the gift is only spendable if a phone number of the mobile device corresponds to a predetermined phone number associated with the gift;
receiving a first selection from a user of the mobile device to accept the gift amount;
displaying the identifier of the gift sender and the custom content;
transmitting a first notification to the gift sender that the gift has been received by the user and the custom content has been displayed to the user; and
after the gift amount has been spent by the user, transmitting a second notification to the gift sender indicating how the gift amount was spent by the user; and
a server configured to:
authenticating the user;
associating, the user with a user account, wherein the user account is linked with a digital wallet of the user;
storing, an association binding the gift sender, the user, and the phone number associated with the gift;
receiving a request to approve a purchase; and
transmitting an approval of the purchase.
